(19) United States
(12) Patent Application Publication
(10) Pub. No.: US 2016/0043580 A1
(43) Pub. Date: Feb. 11, 2016

(54) SYSTEM AND METHOD FOR REDUCING CURRENT VARIABILITY BETWEEN MULTIPLE ENERGY STORAGE DEVICES

(71) Applicant: General Electric Company, Schenectady, NY (US)

(72) Inventors: Kenneth McClellan Rush, JR., Ballston Spa, NY (US); Christopher James Chuah, Clifton Park, NY (US); Chester Stanley Jezierski, JR., Amsterdam, NY (US); Leng Mao, Latham, NY (US); David E. James, Clifton Park, NY (US); Christopher Richard Smith, Saratoga, NY (US)

(21) Appl. No.: 14/453,970

(22) Filed: Aug. 7, 2014

(51) Int. Cl. H02J 7/00; H02J 7/35

(52) U.S. Cl. CPC H02J 7/0021; H02J 7/35

(57) ABSTRACT

The present disclosure is directed to a system and method for reducing current variability between a plurality of energy storage devices, e.g. battery modules. In one embodiment, the method includes determining a resistance of at least two of the plurality of energy storage devices. Another step includes modifying an operating temperature of one or more of the plurality of energy storage devices when the resistance of one or more of the energy storage devices is outside of a predetermined tolerance range for the energy storage devices. Thus, the step of modifying the operating temperature of one or more of the plurality of energy storage devices causes the plurality of energy storage devices to operate within the predetermined tolerance range.

### FIELD OF THE INVENTION

The present disclosure relates generally to energy storage devices, and more particularly to a system and method for reducing current variability between multiple energy storage devices connected in parallel.

### BACKGROUND OF THE INVENTION

Typically, for an off-grid or weak-grid consuming entity, e.g. a telecom facility, the main power source may include a hybrid engine-generator/battery system that can be used in backup situations. For example, if power from the commercial utility is lost, the engine-generator set can be activated to supply power to the facility. Start-up of the engine-generator set, however, takes time; therefore, the battery can provide power during this transitional time period. If the engine-generator set fails to start (e.g., runs out of fuel, suffers a mechanical failure), then the battery is able to provide power for an additional period of time. In this way, electrical energy production does not have to be drastically scaled up and down to meet momentary consumption. Rather, production can be maintained at a more constant level. Thus, electrical power systems can be more efficiently and easily operated at constant production levels.

Other battery applications may include a grid-connected energy storage system or motive-based storage. For example, such grid-connected battery systems can be utilized for peak shaving for commercial/industrial plants, buffering peak loads in distribution grids, energy trading, buffering solar power for night time, upgrade of solar/wind power generation, and/or any other suitable application.

In the battery applications described above, as well as any other suitable battery application, the resistance of a battery can vary at the beginning of its life due to manufacturing variation and over time due to degradation. This can lead to thermal instability of the battery due to heating effects from the increased resistance. If left unaddressed, the thermal runaway can lead to shutdown of the battery. In addition, battery-to-battery resistance and/or current variability can cause oversizing of conductors, fuses, switches, and basically any component in the power wiring of the batteries. Internal control algorithms may also have to be oversized to prevent accidental tripping, thereby causing less safe and less robust systems. Such oversizing may be caused by current differences between the batteries and can be as high as 130% of the average.

Thus, it would be advantageous to provide a system and method for controlling current variability between the batteries connected in parallel to reduce oversizing of the battery components.

### BRIEF DESCRIPTION OF THE INVENTION

Aspects and advantages of the invention will be set forth in part in the following description, or may be obvious from the description, or may be learned through practice of the invention.

One example aspect of the present disclosure is directed to a method for reducing current variability between a plurality of energy storage devices, e.g. battery modules, connected in parallel. In certain embodiments, the plurality of energy storage devices may include at least one of a sodium nickel chloride battery, a sodium sulfur battery, a lithium ion battery, a nickel metal hydride battery, a fuel cell, or similar. A step of the method may include determining an operating parameter of at least two of the plurality of energy storage devices. Another step includes modifying an operating temperature of one or more of the energy storage devices when the operating parameter of one or more of the energy storage devices is outside of a predetermined tolerance range for the plurality of energy storage devices. Thus, the step of modifying the operating temperature of one or more of the plurality of energy storage devices causes the plurality of energy storage devices to operate within the predetermined tolerance range.

In another aspect, the present disclosure is directed to a method for controlling current variability between a plurality of battery modules connected in parallel such that oversizing of battery components can be avoided. The method includes determining a resistance of at least two of the plurality of battery modules. For example, in a particular embodiment, the resistance may be calculated using the terminal voltage, the terminal current, and the open circuit voltage (OCV) of the battery module. Thus, in such an embodiment, the resistance may be calculated using the following formula: battery module internal resistance=(OCV−terminal voltage)/current. In certain embodiments, OCV values may be obtained from a look-up table based on operating parameters such as temperature, battery discharge current and discharge duration. Alternatively, OCV values may be measured, where feasible, by disconnecting one battery at a time from the load, waiting for the voltage to stabilize, and measuring the voltage with no load. Battery module internal resistance may also be calculated, where feasible, from terminal voltage and current measurements at two or more different load points, e.g. Rᵢₙₜₑᵣₙₐₗ=(V₂−V₁)/(I₁−I₂). In still further embodiments, the OCV value may not be needed for the resistance calculation. Thus, the resistance may be determined from the voltage, current, derived state-of-charge (e.g. depth of discharge), and/or resistance trend.

Another step includes modifying an operating temperature of one or more of the battery modules when the resistance of the one or more battery modules is outside of a predetermined tolerance range for the plurality of battery modules, wherein modifying the operating temperature of one or more of the battery modules causes the plurality of battery modules to operate within the predetermined tolerance range. The method also includes determining the resistance of each of the plurality of battery modules after modifying the operating temperature to ensure the resistances of each of the plurality of battery modules is within the predetermined tolerance range.

In yet another aspect, the present disclosure is directed to a system for reducing current variability between a plurality of energy storage devices connected in parallel. The system includes a processor communicatively coupled to one or more sensors. In various embodiments, the sensors are configured to monitor the operating temperature of one or more of the plurality of energy storage devices. In addition, the processor is configured to perform one or more operations. For example, in certain embodiments, the operations include determining a resistance of at least two of the plurality of energy storage devices and modifying an operating temperature of one or more of the plurality of energy storage devices when the resistance of one or more of the energy storage devices is outside of a predetermined tolerance range for the energy storage devices. Further, the step of modifying the operating temperature of one or more of the plurality of energy storage devices causes the plurality of energy storage devices to operate within the predetermined tolerance range.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 illustrates a schematic diagram of one embodiment of a hybrid power system for a telecommunications application configured to implement the system according to the present disclosure;

FIG. 2 illustrates a block diagram of one embodiment of a controller configured to implement the steps of the method according to the present disclosure;

FIG. 3 illustrates a block diagram of one embodiment of a system for reducing current variability between multiple energy storage devices according to the present disclosure; and

FIG. 4 illustrates a flow diagram of one embodiment of a method for reducing current variability between a plurality of energy storage devices according to the present disclosure.

### DETAILED DESCRIPTION OF THE INVENTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

Generally, the present disclosure is directed to a system and method for reducing current variability between multiple battery modules connected in parallel. Thus, the present technology can be utilized in any suitable battery application, including but not limited to a consuming entity, grid-connected energy storage, and/or motive-based storage. In various embodiments, the system determines a resistance of each of the battery modules and modifies an operating temperature of any of the battery modules having a measured resistance that varies in comparison to the remaining battery modules or is outside of a predetermined resistance tolerance range. Depending on battery type and on the temperature range, the internal resistance of a battery may either increase with increasing temperature, or decrease with increasing temperature. For example, for the battery circuits of the present disclosure, if the battery internal resistance increases, the current flow out of the battery decreases, whereas if the battery internal resistance decreases, the current flow out of the battery increases.

Thus, the system can maintain relatively constant current flowing through each of the battery modules since each of the battery modules can operate at a different temperature.

The present disclosure has many advantages not present in the prior art. For example, since the operating temperature of the battery modules impacts battery resistance, modifying the operating temperature of individual battery modules having a resistance higher or lower than a predetermined tolerance range can reduce current variability between the battery modules. Thus, by controlling the operating temperatures of each battery module, the present disclosure reduces battery-to-battery current differences by allowing the battery modules to operate at more than one temperature. Reducing current variability eliminates the need to oversize battery components, such as conductors, fuses, switches, cells, or similar. Thus, the present disclosure provides a more robust, safe, and economical energy storage device.

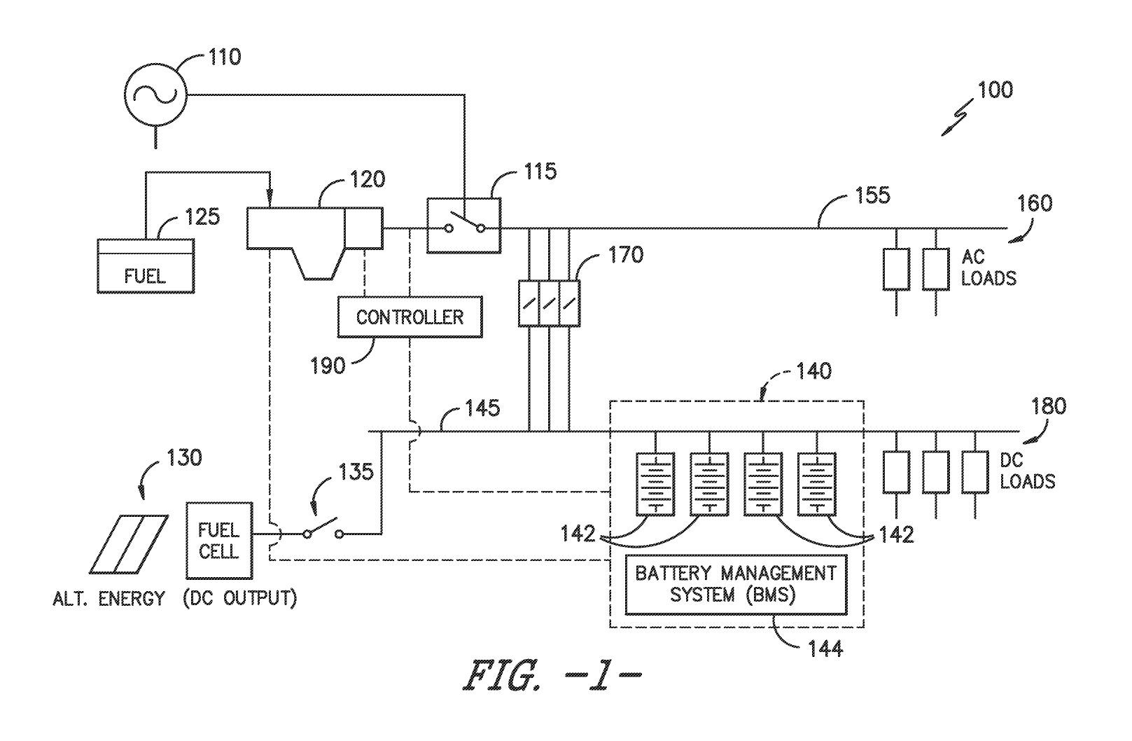

Referring now to the drawings, FIG. 1 is an illustration of one embodiment of a hybrid power system 100 for a telecom base transceiver station (BTS) that can benefit from the system and method of the present disclosure. In addition, it should be understood by those of ordinary skill in the art that the system and method of the present disclosure can be used in any other suitable battery application, e.g. grid-connected energy storage, motive-based storage, or similar, and the embodiment of FIG. 1 is provided for illustrative purposes only. As shown, FIG. 1 depicts multiple sources of power including an AC power grid 110, an engine-generator power source or engine-generator set (EGS) 120, alternative energy source 130, and a battery power source 140, which is an energy storage device (ESD). A transfer switch 115 allows transfer of operation between the AC power grid 110 and the EGS 120, as well as other AC electrical power that may be available. The EGS 120 typically runs on fuel (e.g., diesel fuel) provided by a fuel source 125 (e.g., a storage tank). An availability switch 135 allows for alternate energy sources 130 (e.g. solar, wind, or fuel cell), if available, to be switched in to a DC bus 145 or an AC bus 155 of the power system 100 as well. If switching into the AC bus 155, an inverter 170 (described below) can be coupled between the alternate energy source 130 and the AC bus 155.

The battery power source 140 is an electrical power source. More specifically, in certain embodiments, the battery power source 140 may include one or more battery modules 142. Such battery modules 142 may contain any suitable batteries known in the art. For example, in various embodiments, the battery modules 142 may contain one or more sodium nickel chloride batteries, sodium sulfur batteries, lithium ion batteries, nickel metal hydride batteries, fuel cells, or similar. For example, sodium nickel chloride batteries are particularly suitable due to their short charge times that can drive the EGS 120 to peak efficiency, thereby reducing fuel costs for the BTS. In addition, sodium nickel chloride battery performance is not affected by ambient temperature; therefore, such batteries can be used at sites with extreme temperature variations. Further, the battery module 142/batteries are typically available in three size ranges, namely kWh, MWh and GWh.

The AC bus 155 provides AC power to drive AC loads 160 of the system such as, for example, lighting and/or air conditioning of a telecom base transceiver station (BTS). Furthermore, the AC bus 155 can provide AC power to a bi-directional inverter 170 which converts AC power to DC power which provides DC power to the DC bus 145 to drive DC loads 180 of the power system 100. Example DC loads of the power system 100 include radios, switches, and amplifiers of the BTS. The DC bus 145 also provides DC power from the inverter 170 to charge the battery power source 140 and provides DC power from the battery power source 140 to the DC loads 180 as the battery power source 140 discharges. The inverter 170 may regulate DC power from a DC electrical power source (e.g., a solar energy system or a fuel cell energy system) instead of an AC electrical power source. In general, a primary power source may provide AC or DC electrical power that is used by an ESD (e.g., by the DC battery power source 140) of the power system 100.

During operation of the hybrid power system 100, when the EGS 120 is on, the EGS 120 provides power to the DC loads 180 and to the battery power source 140 during a charging part of the cycle. When the EGS 120 is off, the battery power source 140 provides power to the DC loads 180 during a discharging part of the cycle. The state of the battery power source 140 can be estimated by observations of the current of the battery power source 140. More specifically, the series or recharge resistance profile is learned or otherwise determined as a function of charge status. This characteristic is then monitored and updated as the battery power source 140 ages.

The battery power source 140 may be controlled by the battery management system (BMS) 144. As used herein, the BMS 144 generally refers to any electronic system that manages a rechargeable battery module (e.g. cell or battery pack), such as by protecting the battery module from operating outside a safe operating mode, monitoring a state of the battery module, calculating and reporting operating data for the battery module, controlling the battery module environment, and/or any other suitable control actions. For example, in several embodiments, the BMS 144 is configured to monitor and/or control operation of one or more energy storage devices (e.g. the battery modules 142). Further, the BMS 144 may be configured to communicate with the EGS 120 by sending a start-up command so as to start-up the engine of the EGS 120 in accordance with control logic of the BMS 144. In addition, the BMS 144 may be, for example, a logic controller implemented purely in hardware, a firmware-programmable digital signal processor, or a programmable processor-based software-controlled computer.

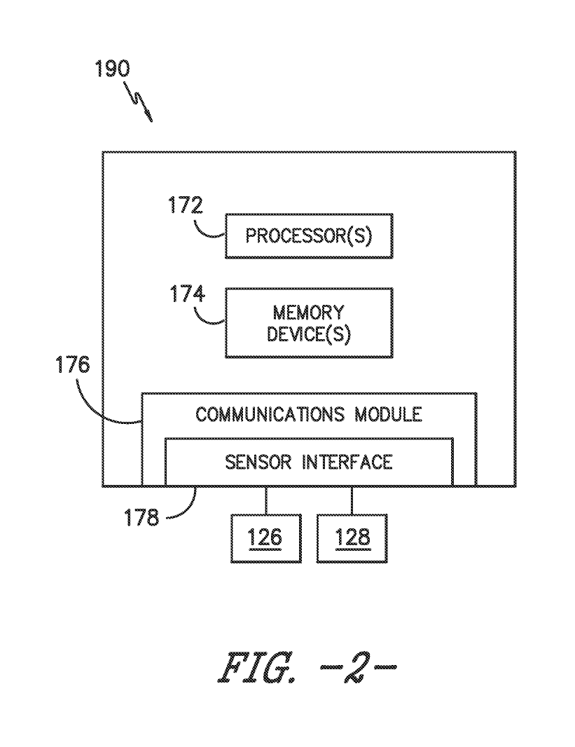

The power system 100 may also include a controller 190 that is configured to monitor and/or control various aspects of the power system 100 as shown in FIGS. 1 and 2. For example, the controller 190 may be configured to command the engine of the EGS 120 to turn on or off in accordance with control logic of the controller 190 or may implement the method steps according to the present disclosure as described herein. In accordance with various embodiments, the controller 190 may be a separate unit (as shown) or may be part of the BMS 144 of the battery power source 140.

Referring particularly to FIG. 2, the controller 190 may have any number of suitable control devices. As shown, for example, the controller 190 can include one or more processor(s) 172 and associated memory device(s) 174 configured to perform a variety of computer-implemented functions and/or instructions (e.g., performing the methods, steps, calculations and the like and storing relevant data as disclosed herein). The instructions when executed by the processor 172 can cause the processor 172 to perform operations according to the present disclosure. Additionally, the controller 190 may also include a communications module 176 to facilitate communications between the controller 190 and the various components of the system 100. Further, the communications module 176 may include a sensor interface 178 (e.g., one or more analog-to-digital converters) to permit signals transmitted from one or more sensors 126, 128 to be converted into signals that can be understood and processed by the processors 172. It should be appreciated that the sensors (e.g. sensors 126, 128) may be communicatively coupled to the communications module 176 using any suitable means. For example, as shown in FIG. 2, the sensors 126, 128 are coupled to the sensor interface 178 via a wired connection. However, in other embodiments, the sensors 126, 128 may be coupled to the sensor interface 178 via a wireless connection, such as by using any suitable wireless communications protocol known in the art. As such, the processor 172 may be configured to receive one or more signals from the sensors 126, 128.

As used herein, the term “processor” refers not only to integrated circuits referred to in the art as being included in a computer, but also refers to a controller, a microcontroller, a microcomputer, a programmable logic controller (PLC), an application specific integrated circuit, and other programmable circuits. The processor 172 is also configured to compute advanced control algorithms and communicate to a variety of Ethernet or serial-based protocols (Modbus, OPC, CAN, etc.). Additionally, the memory device(s) 174 may generally comprise memory element(s) including, but not limited to, computer readable medium (e.g., random access memory (RAM)), computer readable non-volatile medium (e.g., a flash memory), a floppy disk, a compact disc-read only memory (CD-ROM), a magneto-optical disk (MOD), a digital versatile disc (DVD) and/or other suitable memory elements. Such memory device(s) 174 may generally be configured to store suitable computer-readable instructions that, when implemented by the processor(s) 172, configure the controller 190 to perform the various functions as described herein.

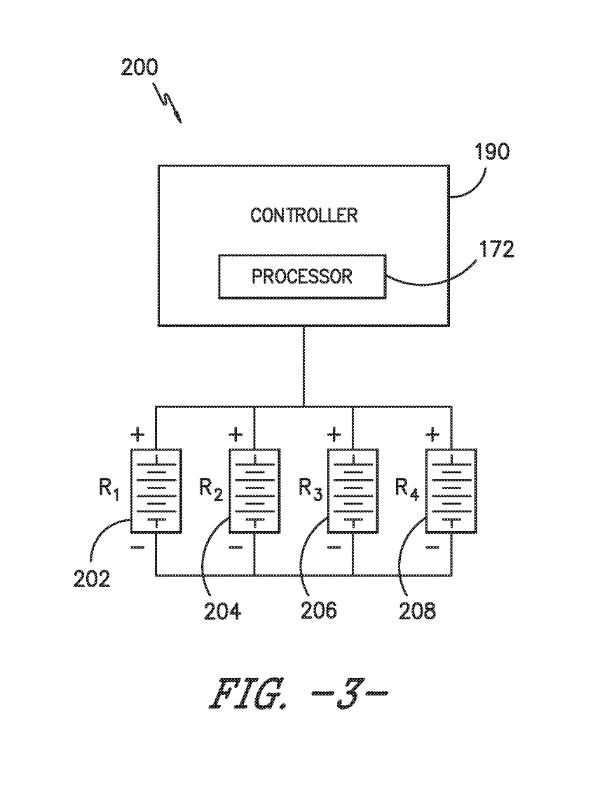

Referring now to FIG. 3, a system 200 for reducing current variability between a plurality of energy storage devices according to the present disclosure is illustrated. In a particular embodiment, for example, the system 200 may be integrated with the controller 190 or BMS 144 of the power system 100 described above to control operation of one or more energy storage devices. Thus, the system 200 is configured to maintain a relatively uniform current flowing through the battery modules 142 during operation of the power system 100. More specifically, as shown, the system 200 includes a plurality of battery modules 202, 204, 206, 208 communicatively coupled to the processor 172. More specifically, the illustrated system 200 includes four battery modules, though it should be understood that the system 200 may include any number of battery modules, including more than four or less than four. In addition, the battery modules 202, 204, 206, 208 may be connected using any suitable topology. For example, as shown, the battery modules 202, 204, 206, 208 are connected in parallel. In additional embodiments, some of the battery modules 202, 204, 206, 208 may be connected in parallel, whereas additional battery modules may be connected in series. In addition, each of the battery modules may include any number of individual cells or batteries. For example, one battery module may include a single battery, whereas another battery module may include two batteries. In still additional embodiments, the battery modules may include more than two batteries. More specifically, the battery modules may include one or more batteries connected in a series string.

Thus, the processor 172 is configured to perform one or more operations so as to reduce current variability between the battery modules 202, 204, 206, 208. For example, in one embodiment, the processor 172 is configured to determine at least one operating parameter of at least two of the battery modules 202, 204, 206, 208 so as to have at least two parameters to compare. More specifically, in a particular embodiment, the processor 172 is configured to determine a resistance (e.g. R₁, R₂, R₃, R₄) of at least two of the plurality of the battery modules 202, 204, 206, 208. For example, in certain embodiments, the resistance may be calculated using the terminal voltage, the terminal current, and the open circuit voltage (OCV) of the battery module. Thus, in a particular embodiment, the resistance may be calculated using the following formula: battery module internal resistance=(OCV−terminal voltage)/current. In certain embodiments, OCV values may be obtained from a look-up table based on operating parameters such as temperature, battery discharge current and discharge duration. Alternatively, OCV values may be measured, where feasible, by disconnecting one battery at a time from the load, waiting for the voltage to stabilize, and measuring the voltage with no load. Battery module internal resistance may also be calculated, where feasible, from terminal voltage and current measurements at two or more different load points, e.g. Rᵢₙₜₑᵣₙₐₗ=(V₂−V₁)/(I₁−I₂).

Based on the measured or calculated resistances of the battery modules 202, 204, 206, 208, the processor 172 can modify an operating temperature of one or more of the battery modules 202, 204, 206, 208 (depending on battery type) when the resistance of one or more of the battery modules 202, 204, 206, 208 varies in comparison to the remaining battery modules 202, 204, 206, 208. For example, for sodium nickel chloride batteries, increasing the operating temperature can decrease the battery internal resistance and decreasing the temperature can increase the battery internal resistance.

For other battery types, e.g. NaS, Li-Ion, and/or lead-acid batteries, increasing the temperature can also decrease the battery internal resistance and decreasing the temperature can increase the battery internal resistance. More specifically, if the resistance in one or more of the battery modules 202, 204, 206, 208 is below a predetermined tolerance range, the processor 172 is configured to increase or decrease the operating temperature (depending on battery type) of one or more of the battery modules with varying resistances so as to reduce current variability between the battery modules 202, 204, 206, 208. In contrast, if the resistance in one or more of the battery modules 202, 204, 206, 208 is above a predetermined tolerance range, the processor 172 is configured to decrease or increase the operating temperature (depending on battery type) of the varying battery modules so as to reduce current variability between the battery modules 202, 204, 206, 208. For example, if the processor 172 determines that the resistances R₁, R₂, and R₄ for battery modules 202, 204, and 208 result in a current of approximately 10 amperes, but the resistance R₃ for battery module 206 results in a current of approximately 8 amperes, then the processor 172 is configured to decrease or increase the operating temperature of battery module 206 (depending on battery type) so as to reduce the current variability between the battery modules 202, 204, 206, 208.

In addition, each of the battery modules 202, 204, 206, 208 may be separately contained in individual thermally isolated compartments or boxes such that the operating temperature between the battery modules 202, 204, 206, 208 can be tightly controlled. For example, many sodium nickel chloride battery modules use solid fiber-type insulation plus a vacuum jacket within each module, e.g. between the inner box containing the cells and the outside case. In addition, there is typically an air gap and enclosure structure between battery modules that provides additional thermal isolation between battery modules. The predetermined tolerance range as described herein is the desired operating resistance for each battery module plus or minus (+/−) a 5% variation assuming that the operating temperature measurements are accurate and measured at the same time. In further embodiments, the predetermined tolerance range may have a tolerance of greater than plus or minus 5% or less than plus or minus 5%, such as +/−10% or +/−15%. In addition, the predetermined tolerance range can be stored in the memory device of the controller 190 as a comparison for the measured resistance for each of the battery modules 202, 204, 206, 208.

In certain embodiments, the processor 172 may increase the operating temperature of one or more of the battery modules 202, 204, 206, 208 by sending a start signal to a heater, burner, or electric heater jacket around the outside of the battery module or transferring heat to one or more of the other battery modules 202, 204, 206, 208 via a heating medium. In additional embodiments, the processor 172 may increase the operating temperature using any other suitable heating application. More specifically, in a particular embodiment, the processor 172 may transfer or circulate a heat transfer medium, such as a hot fluid, e.g. liquid or hot gas, in or around one or more of the batteries so as to increase the operating temperature thereof. For example, a portion of the hot exhaust air from one or more battery modules could be diverted to the battery module that needs to be heated up, either by injecting the hot air into the battery air inlet port, or by circulating the hot air around the battery module if the battery module is placed into a separate enclosure containing an air jacket between the battery module and the enclosure.

Alternatively, the processor 172 may decrease the operating temperature of one or more of the battery modules 202, 204, 206, 208 by sending a start signal to a cooler or similar, transferring heat away from one or more of the other battery modules 202, 204, 206, 208, or using a cooling medium. For example, grid and mining batteries may utilize centrifugal blowers that take ambient (i.e. cool) air and blow it through an inlet port, e.g. through internal battery module passages, picking up heat to cool the battery. For grid batteries, the hot air is exhausted through an outlet port and directed up an enclosure chimney to an air diffuser at the top of the enclosure. For mining batteries, a similar hot air exhaust mechanism may be used. In further embodiments, the processor 172 may decrease the operating temperature using any other suitable cooling application, such as through heat loss.

As mentioned, the processor 172 may be communicatively coupled to one or more sensors (e.g. sensors 126, 128). Thus, the sensors may be configured to monitor the operating temperature of the battery modules 202, 204, 206, 208. Accordingly, the sensors can send a signal to the processor 172 as the operating temperature of the one or more battery modules 202, 204, 206, 208 is either increased or decreased such that the processor 172 can determine when to stop or start heating or cooling the one or more battery modules 202, 204, 206, 208.

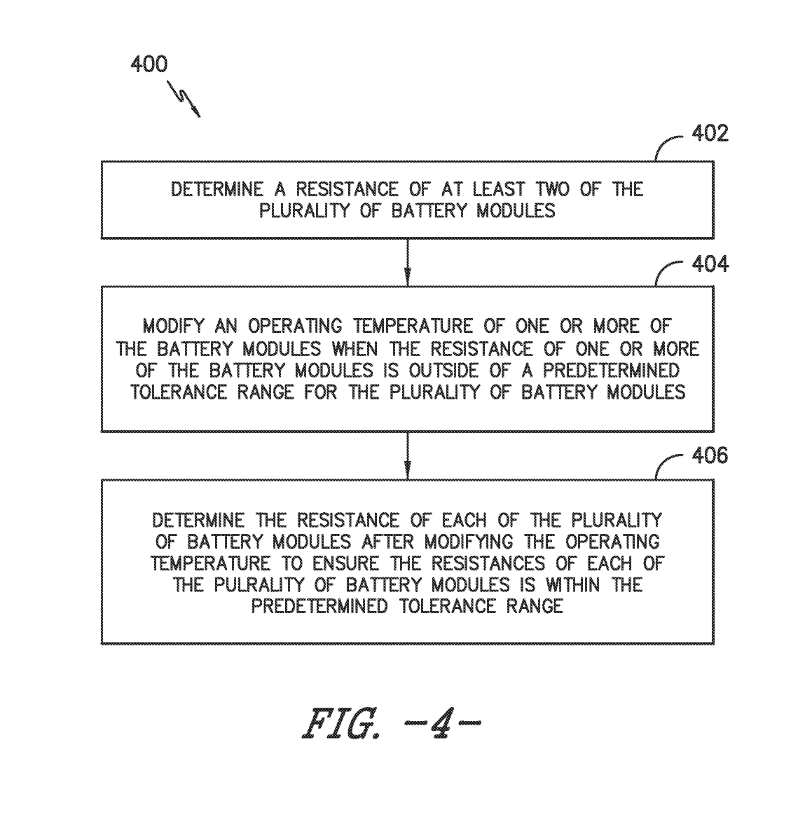

Referring now to FIG. 4, a flow diagram of an example method 400 for reducing current variability between a plurality of battery modules connected in parallel so as to reduce oversizing of individual battery components is illustrated. At (402), the method 400 includes determining a resistance of at least two of the plurality of battery modules. At (404), the method 400 includes modifying an operating temperature of one or more of the battery modules when the resistance of the one or more battery modules is outside of a predetermined tolerance range for the plurality of battery modules. Thus, modifying the operating temperature of one or more of the battery modules reduces current variability between the plurality of battery modules. At (406), the method 400 includes determining the resistance of each of the plurality of battery modules after modifying the operating temperature to ensure the resistances of each of the plurality of battery modules is within the predetermined tolerance range.

Although specific features of various embodiments of the invention may be shown in some drawings and not in others, this is for convenience only. In accordance with the principles of the invention, any feature of a drawing may be referenced and/or claimed in combination with any feature of any other drawing.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A method for reducing current variability between a plurality of energy storage devices connected in parallel, the method comprising:
determining at least one operating parameter of at least two of the plurality of energy storage devices; and,
modifying an operating temperature of one or more of the plurality of energy storage devices when the operating parameter of one or more of the energy storage devices is outside a predetermined tolerance range,
wherein modifying the operating temperature of one or more of the plurality of energy storage devices causes the plurality of energy storage devices to operate within the predetermined tolerance range.

2. The method of claim 1, wherein the operating parameter comprises at least one of or a combination of the following: a resistance, a state of charge of one or more of the energy storage devices, a number of operational cells within one or more of the energy storage devices, line losses, and an actual operating temperature of one or more of the energy storage devices.

3. The method of claim 1, wherein the energy storage devices comprise at least one of a battery or a battery module.

4. The method of claim 3, wherein the battery module comprises one or more battery series strings.

5. The method of claim 1, wherein the energy storage devices are separately contained in individual thermally isolated compartments.

6. The method of claim 2, further comprising determining a battery type of the battery module and based on the battery type, increasing the operating temperature of one or more of the energy storage devices when the resistance in one or more of the plurality of energy storage devices is below the predetermined tolerance range so as to reduce current variability between the plurality of energy storage devices.

7. The method of claim 2, further comprising determining a battery type of the battery module and based on the battery type, increasing the operating temperature of one or more of the energy storage devices when the resistance in one or more of the plurality of energy storage devices is above the predetermined tolerance range so as to reduce current variability between the plurality of energy storage devices.

8. The method of claim 2, further comprising determining a battery type of the battery module and based on the battery type, decreasing the operating temperature of one or more of the energy storage devices when the resistance in one or more of the plurality of energy storage devices is below the predetermined tolerance range so as to reduce current variability between the plurality of energy storage devices.

9. The method of claim 2, further comprising determining a battery type of the battery module and based on the battery type, decreasing the operating temperature of one or more of the energy storage devices when the resistance in one or more of the plurality of energy storage devices is above the predetermined tolerance range so as to reduce current variability between the plurality of energy storage devices.

10. The method of claim 6, wherein increasing the operating temperature of one or more of the energy storage devices further comprises utilizing at least one of a heater, a burner, or heat transfer from one or more of the energy storage devices, wherein utilizing heat transfer from one or more of the energy storage devices further comprises using a heat transfer medium, wherein the heat transfer medium comprises one of a liquid or a gas.

11. The method of claim 8, wherein decreasing the operating temperature of one or more of the energy storage devices further comprises utilizing at least one of a cooler, or heat loss.

12. The method of claim 1, wherein the plurality of energy storage devices comprise at least one of a sodium nickel chloride battery, a sodium sulfur battery, a lithium ion battery, a nickel metal hydride battery, or a fuel cell.

13. A method for controlling current variability between a plurality of battery modules connected in parallel such that oversizing of individual battery components can be avoided, the method comprising:
determining a resistance of at least two of the plurality of battery modules;
modifying an operating temperature of one or more of the battery modules when the resistance of the one or more battery modules is outside of a predetermined tolerance range for the plurality of battery modules, wherein modifying the operating temperature of one or more of the battery modules causes the plurality of battery modules to operate within the predetermined tolerance range; and,
determining the resistance of the at least two battery modules after modifying the operating temperature to ensure the resistances of the at least two battery modules is within the predetermined tolerance range.

14. The method of claim 13, further comprising determining a battery type of the battery module and based on the battery type, increasing the operating temperature of one or more of the battery modules when the resistance in one or more of the battery modules is below the predetermined tolerance range so as to reduce current variability between the plurality of battery modules.

15. The method of claim 13, further comprising determining a battery type of the battery module and based on the battery type, increasing the operating temperature of one or more of the battery modules when the resistance in one or more of the plurality of battery modules is above the predetermined tolerance range so as to reduce current variability between the plurality of battery modules.

16. The method of claim 13, further comprising determining a battery type of the battery module and based on the battery type, decreasing the operating temperature of one or more of the battery modules when the resistance in one or more of the plurality of battery modules is below the predetermined tolerance range so as to reduce current variability between the plurality of battery modules.

17. The method of claim 13, further comprising determining a battery type of the battery module and based on the battery type, decreasing the operating temperature of one or more of the battery modules when the resistance in one or more of the plurality of battery modules is above the predetermined tolerance range so as to reduce current variability between the plurality of battery modules.

18. The method of claim 14, wherein increasing the operating temperature of one or more of the battery modules further comprises utilizing at least one of a heater, a burner, or heat transfer from one or more of the battery modules, wherein utilizing heat transfer from one or more of the battery modules further comprises using a heat transfer medium, wherein the heat transfer medium comprises one of a liquid or a gas.

19. The method of claim 17, wherein decreasing the operating temperature of one or more of the battery modules further comprises utilizing at least one of a cooler or heat loss.

20. A system for reducing current variability between a plurality of energy storage devices connected in parallel, the system comprising:
a processor communicatively coupled to one or more sensors, wherein the processor is further configured to perform one or more operations, the operations comprising:
determining a resistance of at least two of the plurality of energy storage devices, and
modifying an operating temperature of one or more of the plurality of energy storage devices when the resistance of one or more of the energy storage devices is outside of a predetermined tolerance range,
wherein modifying the operating temperature of one or more of the plurality of energy storage devices causes the plurality of energy storage devices to operate within the predetermined tolerance range.
